(19) United States
(12) Patent Application Publication
(10) Pub. No.: US 2025/0354620 A1
(43) Pub. Date: Nov. 20, 2025

(54) Valve Device and Pressure Balancing Assembly

(71) Applicant: Illinois Tool Works Inc., Glenview, IL (US)

(72) Inventors: Zhiming Han, Shanghai (CN); Hui Huang, Shanghai (CN)

(21) Appl. No.: 19/207,062

(22) Filed: May 13, 2025

(30) Foreign Application Priority Data
May 16, 2024 (CN) 202410612260.8
May 9, 2025 (CN) 202510600898.4

(51) Int. Cl. F16K 17/19; F16K 7/17

(52) U.S. Cl. CPC F16K 17/19; F16K 7/17

(57) ABSTRACT

Disclosed is a valve device and a pressure balancing assembly. The valve device includes: a valve body, a valve passage on/off portion and a flange. The valve body has a first axial end, a second axial end, and a valve passage running through the first axial end and the second axial end, the first axial end and the second axial end being disposed opposite to each other, and an outer side portion in a circumferential direction of the valve body includes a connecting portion configured to connect the valve device to a part to be connected. The valve passage on/off portion is connected to the first axial end of the valve body and made of a first material having elasticity, and the valve passage on/off portion is deformable to open or close the valve passage. The flange is connected to the second axial end of the valve body and obliquely extends outwardly in a direction toward the first axial end such that a distal end of the flange is located outside the valve body in a radial direction of the valve device. The distal end of the flange has a contact portion. The connecting portion is made of a second material, the second material having a greater hardness than the first material.

### RELATED APPLICATIONS

The present application claims the benefit of Chinese Patent Application Nos. 202410612260.8, filed May 16, 2024, and 202510600898.4, filed May 9, 2025, each titled “Valve Device and Pressure Balancing Assembly,” the contents of which are hereby incorporated by reference.

### TECHNICAL FIELD

The present disclosure relates to a valve device, and in particular to a valve device for use in a pressure balancing assembly.

### BACKGROUND

Some components of a vehicle need to maintain internal and external pressure balance, such as an expansion tank of a cooling system. The expansion tank has a pressure balancing assembly, such as a pressure balancing cap. The pressure balancing cap is provided with a valve device. When the tank internal pressure exceeds a threshold value, the valve device is positively turned on and can effectively release the system pressure. When the volume of liquid inside the expansion tank decreases upon cooling, creating a negative pressure, the valve device is positively turned on to replenish air, to maintain pressure balance in the expansion tank.

### SUMMARY

The present disclosure relates generally to a pressure balancing assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a pressure balancing assembly according to a first embodiment of the present disclosure.

FIG. 1B is an exploded view of the pressure balancing assembly in FIG. 1A.

FIG. 2A is a perspective view of the valve device in FIG. 1B.

FIG. 2B is a side view of the valve device in FIG. 2A.

FIG. 2C is a perspective view of the valve device in FIG. 2A viewed from another perspective.

FIG. 2D is a cross-sectional view of the valve device in FIG. 2A along A-A in FIG. 2C.

FIG. 3A is a perspective view of the support in FIG. 1B.

FIG. 3B is a perspective view of the support in FIG. 3A viewed from another perspective.

FIG. 3C is a schematic cross-sectional perspective view of the support in FIG. 3A.

FIG. 4 is a perspective view of the cover in FIG. 1A.

FIG. 5A is a cross-sectional view of the pressure balancing assembly in FIG. 1A.

FIG. 5B is a cross-sectional perspective view of the pressure balancing assembly in FIG. 1A.

FIG. 5C is a schematic cross-sectional view of the pressure balancing assembly engaging with a mounting part in FIG. 5A.

FIG. 6A is a schematic view of a fluid flow direction when an external pressure is smaller than an internal pressure of the mounting part.

FIG. 6B is a schematic view of the fluid flow direction when the external pressure is less than the internal pressure of the mounting part.

FIG. 7A is a perspective view of a valve device according to a second embodiment of the present disclosure.

FIG. 7B is a perspective view of the valve device in FIG. 7A from another perspective.

FIG. 8A is a schematic cross-sectional view of a pressure balancing assembly in a first state of the valve device in FIG. 7A.

FIG. 8B is a schematic cross-sectional view of the pressure balancing assembly in a second state of the valve device in FIG. 7A.

FIG. 9A is an exploded perspective view of a valve device and a support of a pressure balancing assembly according to a third embodiment of the present disclosure.

FIG. 9B is a perspective view of the valve device in FIG. 9A.

FIG. 9C is a perspective view of the support in FIG. 9A.

FIG. 10A is an exploded perspective view of a valve device and a support of a pressure balancing assembly according to a fourth embodiment of the present disclosure.

FIG. 10B is a perspective view of the valve device in FIG. 10A.

FIG. 10C is a perspective view of the support in FIG. 10A.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a valve device, including: a valve body, a valve passage on/off portion and a flange. The valve body has a first axial end, a second axial end, and a valve passage running through the valve body from the first axial end to the second axial end, the first axial end and the second axial end being disposed opposite to each other, and an outer side portion in a circumferential direction of the valve body includes a connecting portion configured to connect the valve device to a part to be connected. The valve passage on/off portion is connected to the first axial end of the valve body and made of a first material having elasticity, and the valve passage on/off portion is deformable to open or close the valve passage. The flange is connected to the second axial end of the valve body and obliquely extends outwardly in a direction toward the first axial end such that a distal end of the flange is located outside the valve body in a radial direction of the valve device. The distal end of the flange has a contact portion. The connecting portion is made of a second material, and the elasticity of the second material is less than that of the first material.

In the valve device as described above, the flange is made of the first material, or an elastic material apart from the first material.

In the valve device as described above, the connecting portion and the valve passage on/off portion are formed into an integral unit by means of a secondary injection molding process.

In the valve device as described above, the connecting portion is configured to be in connection with the part to be connected by means of a snap-fit structure.

In the valve device as described above, in an axial direction of the valve body, the valve body includes a front valve body segment, and the connecting portion includes a first connecting portion segment and a second connecting portion segment. The first connecting portion segment is connected to the front valve body segment, the second connecting portion segment is closer to the valve passage on/off portion than the first connecting portion segment, and the size of an outer periphery of the first connecting portion segment is less than the sizes of the front valve body segment and the second connecting portion segment, such that a groove is formed between the second connecting portion segment, the first connecting portion segment and the front valve body segment, and the connecting portion continuously extends or is intermittently arranged in the circumferential direction.

In the valve device as described above, the valve body includes a plurality of the grooves, which are arranged along the axial direction of the valve body, with a space between adjacent grooves of the plurality of the grooves.

In the valve device as described above, the valve passage on/off portion includes a closure mouth having a slit at the distal end; the closure mouth includes a pair of lips, each of the pair of lips having an inner side portion and an outer side portion, and the pair of lips being configured to be deformable, such that the slit is opened when the pair of lips is subjected to a outward pressure applied to the inner side portions, and the slit is closed when the pair of lips is subjected to an inward pressure applied to the outer side portions.

The present disclosure also provides a pressure balancing assembly, including: a support, and a valve device as described above. The support includes a side wall and a mounting cavity, the side wall enclosing the mounting cavity, and a ledge portion being provided on an inner side of the side wall and continuously extending in a circumferential direction. The valve device is mounted in the mounting cavity and connected to the support via the connecting portion. The pressure balancing assembly has fluid passages, and the flange is configured to abut against or is disengage from the ledge portion to close or open the fluid passages.

In the pressure balancing assembly as described above, the mounting cavity has a first cavity end and a second cavity end in the axial direction of the valve body, and when the pressure balancing assembly is configured such that when a pressure at the first cavity end is greater than a pressure at the second cavity end, a fluid can flow from the valve passage and the valve passage on/off portion to the second cavity end; and when the pressure at the first cavity end is less than the pressure at the second cavity end, the fluid can flow from the fluid passages to the first cavity end.

In the pressure balancing assembly as described above, one of the support and the valve body includes a protrusion, and the other includes a groove; and in the axial direction of the valve body, the height of the groove is greater than that of the protrusion, and the protrusion is movable in the groove in the axial direction of the valve body, such that the valve device can move in the mounting cavity in the axial direction of the valve body.

In the pressure balancing assembly as described above, the support includes a snap-fit portion extending from the inner side of the side wall toward a center line of the support, a distal end of the snap-fit portion forming the protrusion, and at least a portion of the fluid passage being located between the protrusion and the ledge portion and extending in an axial direction of the support to run through the snap-fit portion; and in the axial direction of the valve body, the valve body includes a front valve body segment, and the connecting portion includes a first connecting portion segment and a second connecting portion segment. The first connecting portion segment is connected to the front valve body segment, the second connecting portion segment is closer to the valve passage on/off portion than the first connecting portion segment, and the size of an outer periphery of the first connecting portion segment is less than the sizes of the front valve body segment and the second connecting portion segment, such that a groove is formed between the second connecting portion segment, the first connecting portion segment and the front valve body segment and is capable of accommodating a plurality of the protrusions.

In the pressure balancing assembly as described above, the snap-fit portion includes a plurality of grippers, which respectively extending from the inner side of the side wall toward the center line of the support, distal ends of the plurality of grippers forming the plurality of protrusions, adjacent grippers of the plurality of grippers having a space therebetween to form recess portions which form at least a portion of the fluid passages.

In the pressure balancing assembly as described above, the plurality of grippers extend from an inner side of the ledge portion, angled away from the flange.

In the pressure balancing assembly as described above, the groove continuously extends in a circumferential direction.

In the pressure balancing assembly as described above, a plurality of the connecting portions are arranged in a spaced manner in the circumferential direction, spacing portions are disposed between adjacent connecting portions, and the size of an outer periphery of the spacing portion is less than the size of the outer periphery of the first connecting portion segment; and the valve device is configured to enable the plurality of the connecting portions to be inserted into the recess portions in the axial direction of the valve body and be rotated by an angle after being inserted in place, such that the spacing portions and the recess portions are aligned and together form the fluid passages.

In the pressure balancing assembly as described above, the distal end of the snap-fit portion continuously extends in the circumferential direction, the snap-fit portion has through holes extending in the axial direction of the valve body and running through the snap-fit portion, and the through holes form the fluid passages; and the connecting portions are arranged in a spaced manner in the circumferential direction.

The pressure balancing assembly as described above further includes a cover, the cover including a cover body portion connected to one end of the support; and the side wall further includes flow ports, the flange and the flow ports being located between the cover body portion and the ledge portion in the axial direction of the valve body.

In the pressure balancing assembly as described above, the cover further includes a cover extension portion, the cover extension portion extending from an edge of the cover body portion in the axial direction of the valve body, having a space with the side wall, and being provided with a thread capable of being connected to the connected part.

The valve device of the pressure balancing assembly in the present disclosure is made of two materials with different properties, so that the valve device is unlikely to be separated from the support due to deformation. In some embodiments of the present disclosure, the support having grippers can facilitate connection of the support to the valve device.

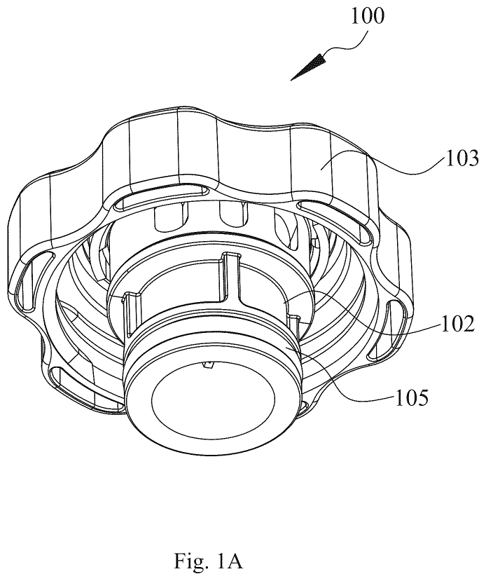

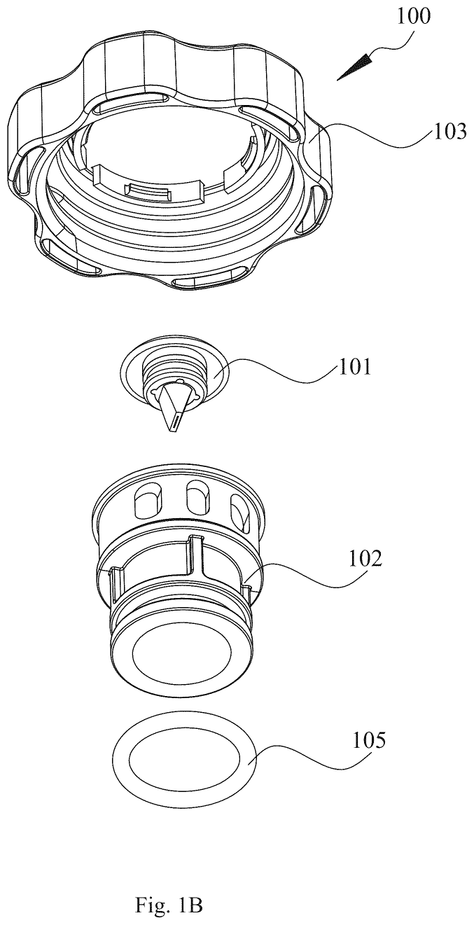

FIG. 1A is a perspective view of a pressure balancing assembly according to a first embodiment of the present disclosure, and FIG. 1B is an exploded view of the pressure balancing assembly in FIG. 1A. FIGS. 1A and 1B show a structure of the pressure balancing assembly. As shown in FIGS. 1A and 1B, the pressure balancing assembly 100 includes a valve device 101, a support 102, a cover 103, and a sealing ring 105. The support 102 is connected to the cover 103, the valve device 101 is disposed in the support 102, and the sealing ring 105 is fitted over the support 102. The pressure balancing assembly 100 is used to be mounted on a container for adjusting the pressure inside the container. The pressure balancing assembly 100 isolates the communication of the inside of the container from the outside when the pressures inside and outside the container are equal, and the pressure balancing assembly 100 can fluidly communicate the inside and outside the container to regulate the pressure inside the container when the pressures inside and outside the container are not equal. In one embodiment of the present disclosure, the pressure balancing assembly 100 is a cap of an expansion tank of a vehicle for regulating the pressure inside the expansion tank.

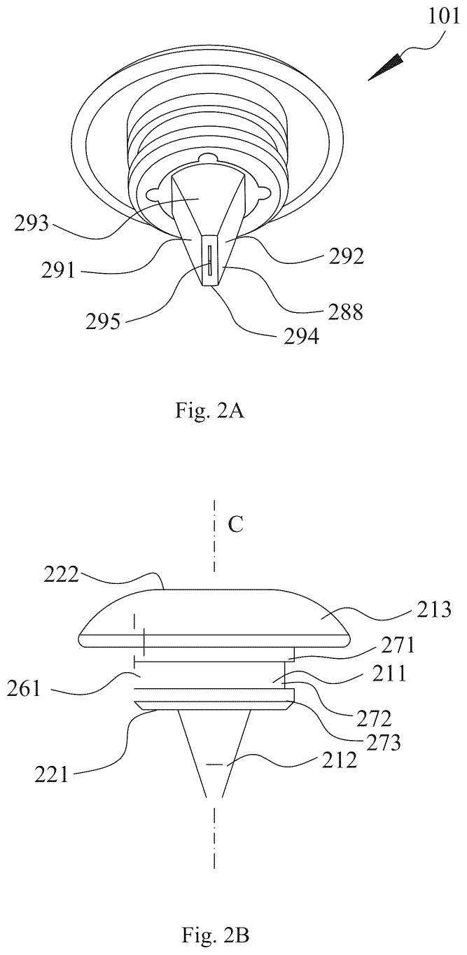

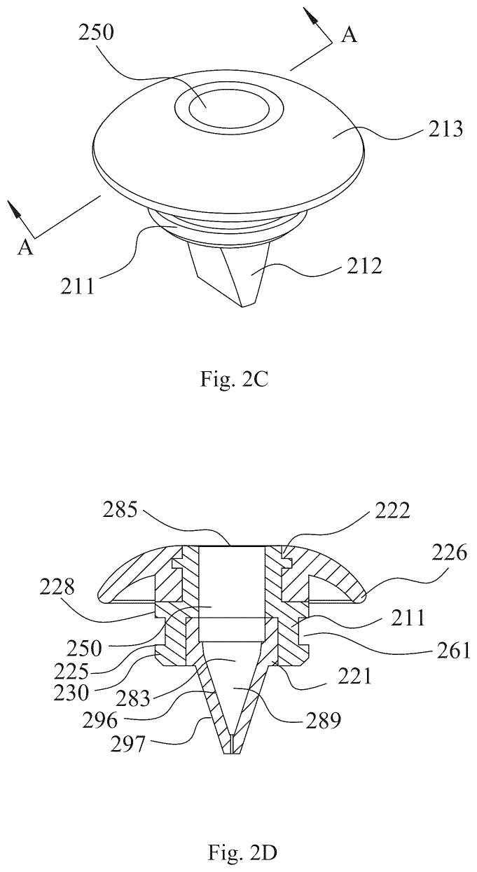

FIG. 2A is a perspective view of the valve device in FIG. 1B, FIG. 2B is a side view of the valve device in FIG. 2A, FIG. 2C is a perspective view of the valve device in FIG. 2A viewed from another perspective, and FIG. 2D is a cross-sectional view of the valve device in FIG. 2A along A-A in FIG. 2C. FIGS. 2A-2D show a structure of the valve device in the present disclosure.

As shown in FIGS. 2A-2D, the valve device 101 includes a valve body 211, a valve passage on/off portion 212 and a flange 213. The valve body 211 extends in an axial direction and has a central axis C. The valve body 211 has a first axial end 221, a second axial end 222, and a valve passage 250 running through the valve body from the first axial end 221 to the second axial end 222. The valve passage 250 forms a fluid outlet 283 and a fluid inlet 285 at the first axial end 221 and the second axial end 222, respectively. The valve passage on/off portion 212 is connected to the first axial end 221 of the valve body 211 and extends substantially in the axial direction of the valve body 211, and the flange 213 is connected to the second axial end 222 of the valve body 211 and obliquely extends substantially in a radial direction. The valve body 211 is substantially in the shape of a hollow cylinder, and the valve body 211 has an outer side portion 228 extending in a circumferential direction. In the axial direction of the valve body 211, the outer side portion 228 includes a front valve body segment 271 and a connecting portion 230. The connecting portion 230 can engage with the support 102 to connect the valve device 101 to the support 102. The connecting portion 230 includes a first connecting portion segment 272 and a second connecting portion segment 273. The size of an outer periphery of the first connecting portion segment 272 is smaller than the size of an outer periphery of the second connecting portion segment 273, so that a step surface 225 is formed between the first connecting portion segment 272 and the second connecting portion segment 273. The longitudinal section of the connecting portion 230 has a hook-like shape, such that a snap-fit structure can be formed to snap-fit with a corresponding part of the support 102.

The first connecting portion segment 272 is connected to the front valve body segment 271, the second connecting portion segment 273 is closer to the valve passage on/off portion 212 than the first connecting portion segment 272, and the size of an outer periphery of the front valve body segment 271 is greater than the size of the first connecting portion segment 272, such that a groove 261 is formed between the second connecting portion segment 273, the first connecting portion segment 272 and the front valve body segment 271. The corresponding part of the support can enter into the groove 261. The groove 261 extends continuously in the circumferential direction of the valve body 211. In other embodiments, the groove 261 is arranged discontinuously in the circumferential direction of the valve body 211.

The flange 213 extends outwardly beyond the valve body 211 from an outer side of the second axial end 222 of the valve body 211 and inclines downwardly toward the first axial end 221. That is, the distal end of the flange 213 is located outside the valve body 211 in the radial direction of the valve body 211. The distal end of the flange 213 has a contact portion 226. The contact portion 226 can engage with the support 102 to form a seal.

The valve passage on/off portion 212 includes a closure mouth 288. One end of the closure mouth 288 is connected to the valve body 211, and the closure mouth 288 has an internal space 289. The internal space 289 is in communication with the valve passage 250 through the fluid outlet 283. The end of the closure mouth 288 away from the valve body has a slit 295. The slit 295 can be opened or closed. The slit 295 has an elongated shape such that fluid cannot or almost cannot flow through the slit 295 if the slit 295 is closed, while fluid can flow through the slit 295 if the slit 295 is dilated to be opened. Opening or closing the slit 295 can open or close the valve passage 250, and the opening or closing of the valve passage 250 determines whether a fluid can flow in the valve passage 250. The closure mouth 288 includes a pair of oppositely disposed lips 291 and 292, and a pair of transition portions 293 and 294. The lip 291, the transition portion 293, the lip 291 and the transition portion 294 are connected in sequence. The lips 291 and 292 are substantially planar and obliquely extend toward each other from their own proximal ends, and respective proximal ends of the lips are connected to the first axial end 221 of the valve body 211. The proximal ends of the transition portions 293 and 294 are connected to the first axial end 221 of the valve body 211, and two sides of each of the transition portions 293 and 294 in the circumferential direction are connected to the lips 291 and 292, respectively. Each of the lips 291 and 292 has an inner side portion 296 and an outer side portion 297. When the inner side portion 296 or the outer side portion 297 is subjected to pressure, the lips 291 and 292 can be deformed to open or close the slit 295.

The flange 213 is made of a first material having elasticity, and the flange 213 is susceptible to deformation so that the contact portion 226 presses the corresponding part of the support to form a seal. The closure mouth 288 of the valve passage on/off portion 212 is also made of the first material having elasticity, so that the closure mouth 288 is susceptible to deformation to open or close the slit 295. In other embodiments, the flange 213 can be made of other materials having elasticity different from the first material. The slit 295 is opened when the pair of lips 291 and 292 bulge outward due to an outward pressure applied to the inner side portions 296, and the slit 295 is closed when the pair of lips concave inward due to an inward pressure applied to the outer side portions 297. In some embodiments, the first material is a thermoplastic elastomer, rubber or other materials, such as EPDM.

The connecting portion 230 is made of a second material having a certain hardness and have a smaller elasticity than the first material such that the connecting portion 230 has a certain strength. Therefore, the connection between the valve device 101 and the support 102 is reliable, preventing the valve device from disengaging from the support 102 due to the deformation of the valve device 101 during use. In some embodiments, the valve passage on/off portion 212 and the connecting portion 230 are formed into an integral unit by means of the secondary injection molding process. In another embodiment of the present disclosure, the valve body 211 may be made entirely of the second material and is formed into an integral unit with the flange 213 by means of the secondary injection molding process. In some embodiments, the second material is a plastic material with certain hardness, such as nylon, PA and PP.

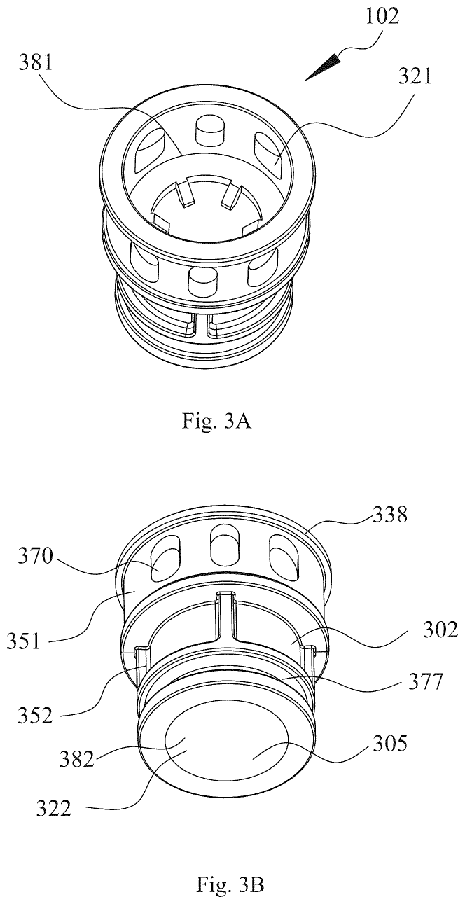

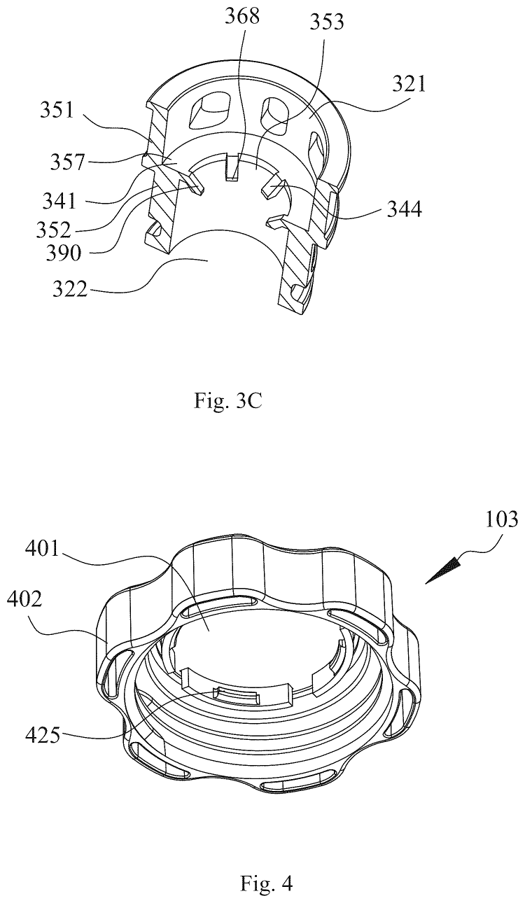

FIG. 3A is a perspective view of the support in FIG. 1B, FIG. 3B is a perspective view of the support in FIG. 3A viewed from another perspective, and FIG. 3C is a schematic cross-sectional perspective view of the support in FIG. 3A.

The support 102 is made of a material having certain hardness to support the valve device 101. As shown in FIGS. 3A-3C, the support 102 has a side wall 302, a mounting cavity 305 and a snap-fit portion 390. The side wall 302 extends in a circumferential direction and in an axial direction such that the support 102 is formed to have a substantially cylindrical structure. The mounting cavity 305 is enclosed by the side wall 302. The snap-fit portion 390 is connected to an inner side of the side wall 302 and is located in the mounting cavity 305. The mounting cavity 305 extends in the axial direction and has a first cavity end 321 and a second cavity end 322. In one embodiment of the present disclosure, the first cavity end 321 and the second cavity end 322 include a first end opening 381 and a second end opening 382, respectively. The side wall 302 has a front segment 351 and a rear segment 352. An inner diameter of the front segment 351 is greater than an inner diameter of the rear segment 352, so that on the inner side of the side wall 302, a step surface 357 is form at the connection between the front segment 351 and the rear segment 352. The step surface 357 continuously extends in the circumferential direction, forming a ledge portion 341 continuously extending in the circumferential direction. The snap-fit portion 390 includes a plurality of grippers 344. Each gripper 344 is connected to the inner side of the side wall 302 at one end with extending from the inner side of the side wall 302 toward the central axis of the mounting cavity 305 and inclining downwardly from the inner side of the side wall 302 toward the second cavity end 322. In one embodiment of the present disclosure, the connections between the grippers 344 and the side wall 302 are located at an end of the rear segment 352 close to the front segment 351. The grippers 344 are uniformly distributed in the circumferential direction, and a recess portion 353 is formed between adjacent grippers. Therefore, a recess portion 353 is defined by the surfaces in three directions. A distal end of each gripper forms a protrusion 368. The protrusions 368, together with the connecting portion 230 of the valve device 101 form a snap-fit structure. The grippers 344 are of a cantilever structure having a small amount of elasticity, and the distal ends of the plurality of grippers 344 can be deflected slightly away from each other, thereby facilitating the mounting of the valve device 101 into the support 102.

The front segment 351 of the side wall 302 has flow ports 370. The flow ports 370 can communicate the mounting cavity 305 with the outside of the support 102. The front segment 351 has an annular flange 338. The annular flange 338 is located at the end of the front segment 351 away from the rear segment 352 and extends outwardly in a radial direction from the outer side of the side wall 302.

An annular groove 377 is provided on an outer side of the rear segment 352 of the side wall 302. The annular groove 377 is configured to receive the sealing ring 105.

FIG. 4 is a perspective view of the cover in FIG. 1A. As shown in FIG. 4, the cover 103 includes a cover body portion 401 and a cover extension portion 402. The cover body portion 401 is connected to one end of the support 102, and can cover the first end opening 381 of the first cavity end 321. The cover extension portion 402 extends from an edge of the cover body portion 401 in the axial direction of the valve body 211. There is a distance between the cover extension portion 402 and the side wall 302 of the support 102 when the cover body portion 401 and the support 102 are connected. Snap-fit members 425 are provided on an inner side of the cover body portion 401 and can cooperate with the annular flange 338 of the support 102 to connect the cover 103 to the support 102. The cover body portion 401 covers the first end opening 381 of the support 102 to prevent the fluid from flowing out of the first end opening 381.

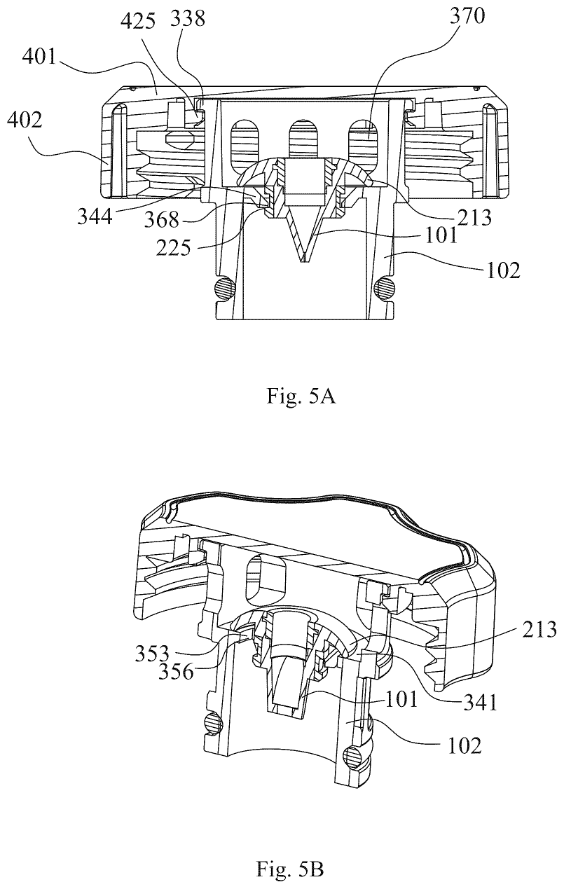

FIG. 5A is a cross-sectional view of the pressure balancing assembly in FIG. 1A, FIG. 5B is a perspective cross-sectional view of the pressure balancing assembly in FIG. 1A, and FIG. 5C is a schematic cross-sectional view of the pressure balancing assembly engaging with a mounting part in FIG. 5A. The position of the section cutting plane of FIG. 5A refers to A-A of FIG. 2C, passing through two grippers of support 102, the section cutting plane of FIG. 5B passes through two recess portions 353 of the support 102, and FIG. 5C has a same cutting position with FIG. 5A.

As shown in FIGS. 1A and 5A, the pressure balancing assembly further includes a cover 103. As shown in FIGS. 5A-5C, the support 102 is connected to the cover 103 since the snap-fit members 425 engage the annular flange 338 above the annular flange 338. The cover extension portion 402 extends in an axial direction toward the rear segment 352 of the side wall 302 and beyond the flow ports 370. The flange 213 and the flow ports 370 are disposed between the cover body portion 401 and the ledge portion 341 along the axial direction of valve body 211. The valve device 101 is located in the mounting cavity 305, the flange 213 of the valve device 101 abuts against the ledge portion 341, the protrusions 368 of the grippers of the support 102 enter into the groove 261 of the valve device 101, and the cooperation of the flange 213 with the ledge portion 341 can limit the distance by which the valve device 101 moves relative to the support 102 in a direction away from the cover 103. The step surface 225 of the connecting portion 230 of the valve device 101 engage the protrusions 368 of the grippers, preventing the valve device 101 from moving relative to the support 102 toward the cover 103. It should be understood that in other embodiments, the protrusions 368 of the grippers do not engage the step surface 225, but there is a distance between the protrusions 368 of the grippers and the step surface 225 as long as the valve device 101 is connected to the support 102. In such embodiments, the step surface 225 limits the distance by which the valve device 101 moves relative to the support 102 toward the cover 103. In this way, the valve device 101 is held in the support 102 and is not susceptible to disengaging from the support 102. A fluid passage 356 is formed between the surfaces defining a recess portion 353 and the outer side of the valve body 211. The fluid passages 356 can be closed or opened depending on whether the flange 213 is brought into contact with or out of contact with the ledge portion 341, and the opening or closing of the fluid passages 356 refer to whether the fluid can flow in the fluid passage 356. The height of the groove 261 in the axial direction is greater than the height of the protrusions 368 in the axial direction. The height of the groove 261 enables the valve device 101 to move relative to the support 102 along the axial direction by a distance.

During assembly of the pressure balancing assembly, the valve device 101 may first be inserted into the mounting cavity 305 from the first end opening 381. The second connecting portion segment 273 of the valve body 211 of the valve device 101 then presses against the grippers 344 to deflect the grippers outwardly, until the first connecting portion segment 272 is aligned with the distal ends of the grippers 344. At this moment, the grippers 344 are restored to initial status, so that the connecting portion 230 is snap-fitted with the grippers 344. The support 102 is then connected to the cover 103 such that the annular flange 338 of the support 102 engages with the snap-fit members 425 of the cover 103, to connect the support 102 to the cover 103.

As shown in FIG. 5C, the mounting part comprises a pipe opening 501. When the pressure balancing device is connected to the mounting part, at least a portion of the rear segment of the support 102 is inserted into the pipe opening of the mounting part, and a seal is formed between the sealing ring 150 and an inner wall 511 of the pipe opening of the mounting part. The mounting cavity 305 is in fluid communication with the mounting part through the second end opening 382. An outer wall of the pipe opening of the mounting part and the cover extension portion 402 threadably engage with each other by means of the thread provided on the cover extension portion 402 to connect the pressure balancing assembly to the mounting part. A gap is provided between the cover extension portion 402 and the outer wall 512 of the pipe opening to allow the fluid to flow therethrough. The slit 295 of the valve device can be opened or closed such that the valve passage 250 of the valve device 101 is in fluid communication with or fluidly isolated from the internal space of the mounting part through the slit 295.

FIG. 5C shows a state of the valve device 101 when an internal pressure of the mounting part is balanced with the external pressure. When the internal pressure of the mounting part is in balanced with the external pressure, the flange 213 of the valve device 101 abuts against the ledge portion 341, the slit 295 is closed, and the inside of the mounting cavity 305 is not in fluid communication with the outside thereof.

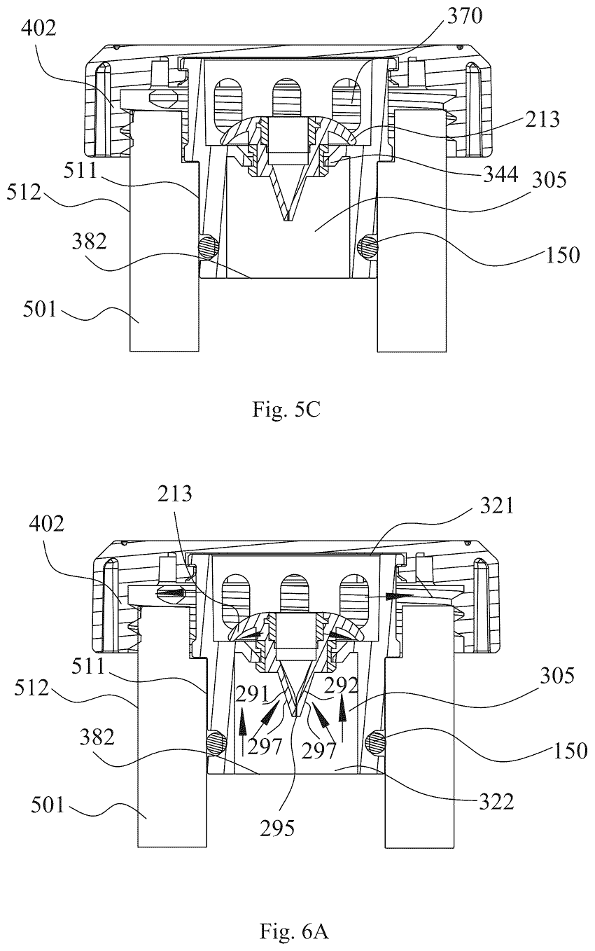

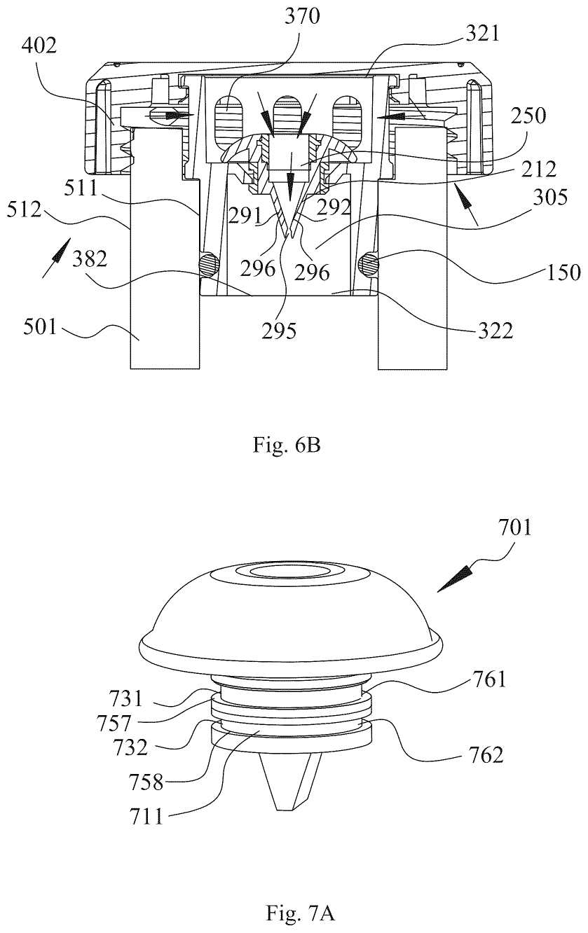

FIG. 6A is a schematic view of a fluid flow direction when the external pressure is less than the internal pressure of the mounting part, and FIG. 6B is a schematic view of the fluid flow direction when the external pressure is greater than the internal pressure of the mounting part. As shown in FIG. 6A, when the external pressure is less than the internal pressure of the mounting part, the pressure at the first cavity end 321 is less than the pressure at the second cavity end 322, and the fluid flows from the inside of the mounting part toward the valve device 101 in the direction shown by the arrows. The pressure of the fluid will press the outer side portions 297 of the lips 291 and 292, causing the lips 291 and 292 to be deformed in a direction toward each other. Thus, the slit 295 is kept closed so that the fluid cannot pass through the slit 295. The fluid flows to the flange 213 from the fluid passages 356 toward the flange 231. The pressure generated by the fluid will cause the flange 213 to be deformed to disengage from the ledge portion 341. That is, the fluid passages 356 are opened. The fluid flows from a space between the flange 213 and the ledge portion 341 to the flow ports 370, and then flows through the gap between the cover extension portion 402 and the outer wall 512 of the pipe opening to the outside of the pressure balancing assembly. When the pressures inside and outside the mounting part are balanced, the valve device returns to the state shown in FIG. 5C.

As shown in FIG. 6B, when the external pressure of the mounting part is greater than the internal pressure thereof, the pressure at the second cavity end 322 is less than the pressure at the first cavity end 321, and the fluid flows from the gap between the cover extension portion 402 and the outer wall 512 of the pipe opening to the interior of the pressure balancing assembly in the direction shown by the arrows. The fluid then enters the valve passage 250 through the flow ports 370 from the fluid inlet 285 of the valve passage, and in turn enters the valve passage on/off portion 212. The pressure of the fluid will press the inner side portions 296 of the lips 291 and 292, to deform the lips 291 and 292 in a direction away from each other, thereby opening the slit 295. Therefore, the valve passage 250 is opened, and the fluid in the valve passage 250 can flow through the slit 295 to the mounting part. When the pressures inside and outside the mounting part are balanced, the valve device returns to the state shown in FIG. 5B. In the position shown in FIG. 6B, the flange 213 abuts against the ledge portion 341, so that a seal is formed between the flange 213 and the ledge portion 341, and the fluid cannot pass therebetween. The fluid passages 356 are thus closed.

When the valve device 101 changes from the state shown in FIG. 5B to the state shown in FIG. 6A, the external pressure applies a push force on the valve device 101 toward the second cavity end 322. This may cause the flange 213 to be slightly deformed. This also may cause the valve device 101 to move relative to the support 102 toward the second cavity end 322 by a small distance, and thus the protrusions 368 of the grippers 344 are disengaged from the step surface 357 of the connecting portion 230. Therefore, in the present disclosure, the valve device 101 may move relative to the support 102 by a distance in the axial direction.

In the present disclosure, the connecting portion 230 is made of a material having a certain hardness and are less susceptible to deformation. Therefore, the connecting portion 230 is less susceptible to deformation to change in the size of the outer periphery thereof caused by the press by the grippers 344, such that the connecting portion 230 is less susceptible to disengaging from the grippers 344. Furthermore, the connecting portion 230 is less susceptible deforming to disengage from the grippers 344 if the valve device 101 is subjected to the internal pressure as shown in FIG. 6A or the external pressure as shown in FIG. 6B. Moreover, after a long period of use, the connecting portion 230 is not susceptible to aging deformation. Therefore, the reliability of the pressure balancing assembly increases since the connecting portion 230 is made of a material having a certain hardness.

In another embodiment of the present disclosure, the positions of the connecting portion and the grippers can be interchanged. That is to say, the connecting portion is provided on the support, and the grippers are provided on the valve device.

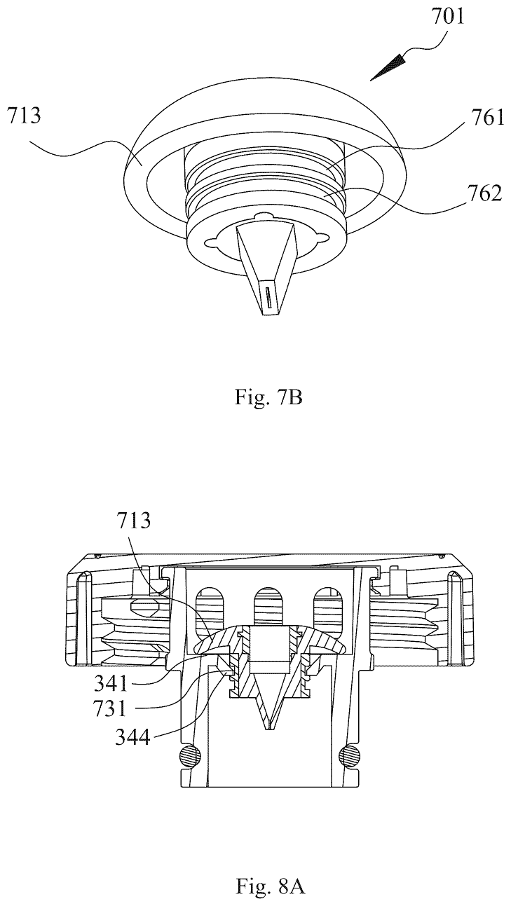

FIG. 7A is a perspective view of a valve device according to a second embodiment of the present disclosure, and FIG. 7B is a perspective view of the valve device in FIG. 7A from another perspective. The embodiment shown in FIGS. 7A and 7B is similar to the embodiment shown in FIG. 1A, except that the valve body of the embodiment shown in FIG. 7A has two grooves, which can meet two pressure needs of the mounting part.

As shown in FIGS. 7A and 7B, the valve body 711 of the valve device 701 includes a first groove 761 and a second groove 762 arranged along the axial direction. The valve body 711 thus has a first connecting portion 731 and a second connecting portion 732. Similar to the embodiment shown in FIG. 1A, each of the first connecting portion 731 and the second connecting portion 732 has a thinner first segment and a thicker second segment, and a step surface is formed between the first segment and the second segment. The first connecting portion 731 has a step surface 757 and the second connecting portion 732 has a step surface 758.

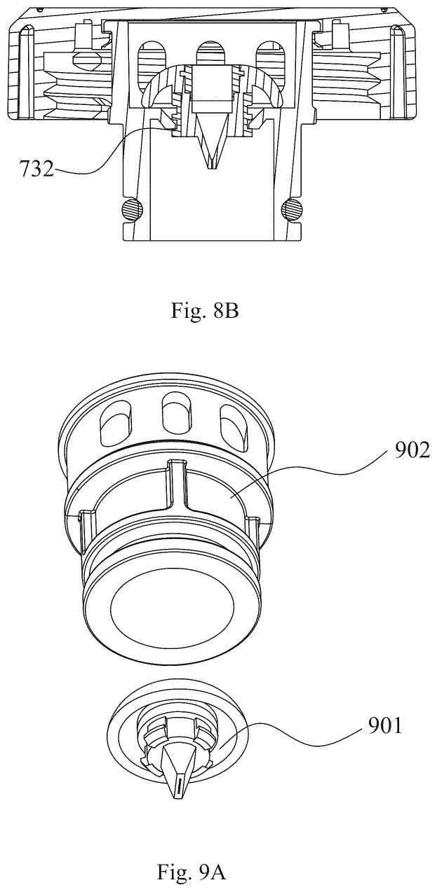

FIG. 8A is a schematic cross-sectional view of a pressure balancing assembly in a first state of the valve device in FIG. 7A, and FIG. 8B is a schematic cross-sectional view of the pressure balancing assembly in a second state of the valve device in FIG. 7A. In the pressure balancing assembly as shown in FIGS. 8A and 8B, the valve device 701 is connected to the support 102 as shown in FIGS. 3A and 3C. As shown in FIG. 8A, when the valve device 701 is in the first state, the first connecting portion 731 is connected to grippers 344. As shown in FIG. 8B, when the valve device 701 is in the second state, the second connecting portion 732 is connected to the grippers 344. Compared with the states shown in FIGS. 8A and 8B, the flange 713 is deformed to a smaller extent in the state shown in FIG. 8B. That is, compared with the status in FIG. 8B, in the state shown in FIG. 8A, the flange 713 exerts a greater pressing force against the ledge portion 341. In the state shown in FIG. 8A, if the internal pressure of the mounting part exceeds the external pressure by a relatively larger margin, the flange 713 can be deformed to leave the ledge portion 341 so as to release the internal pressure of the mounting part. In the state shown in FIG. 8B, if the internal pressure of the mounting part exceeds the external pressure by a relatively smaller margin, the flange 713 can be deformed to leave the ledge portion 341 so as to release the internal pressure of the mounting part. The valve device 701 can meet different internal-pressure release needs of the mounting part.

In another embodiment of the present disclosure, the valve device may be provided with more connecting portions to meet more pressure-release needs.

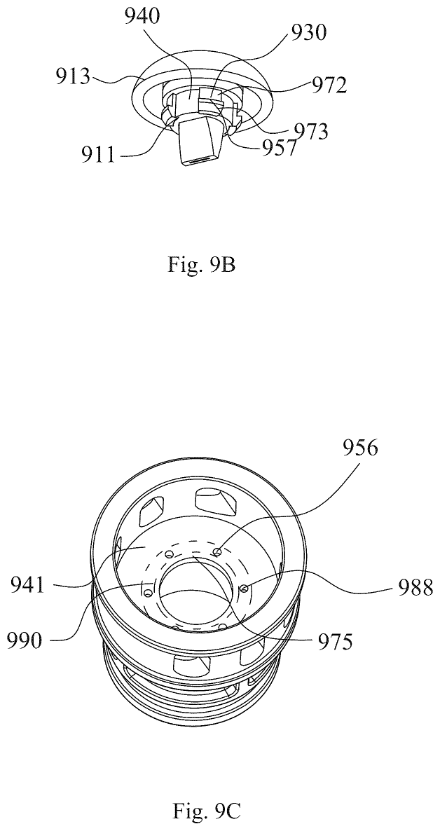

FIG. 9A is an exploded perspective view of a valve device and a support of a pressure balancing assembly according to a third embodiment of the present disclosure, FIG. 9B is a perspective view of the valve device in FIG. 9A, and FIG. 9C is a perspective view of the support in FIG. 9A.

As shown in FIGS. 9A-9B, the pressure balancing assembly includes a valve device 901 which is similar to the valve 101 in FIG. 1A. Like the valve device 101, The valve device 901 has connecting portions 930 and a flange 913. The connecting portions 930 each includes a first segment 972 having a smaller outer periphery size and a second segment 973 having a greater outer periphery size. Step surfaces 957 are formed between the second segments 973 and the first segments 972. The step surfaces 957 can engage with a corresponding protrusion of the support 902. The differences between the valve device 901 and the valve device 101 are described in the below. Unlike the valve device 101, the connecting portions 930 are arranged in a spaced manner in the circumferential direction, and a spacing portion 940 is disposed between adjacent connecting portions 930. The size of an outer periphery of the spacing portion 940 is less than the size of the outer periphery of the first connecting portion segment 972 of the connecting portion 930. That is, the spacing portion 940 forms a recess with respect to the first connecting portion segment 972 of the connecting portion 930. In one embodiment of the present disclosure, the spacing portion 940 is made of a first material having elasticity to facilitate the mounting of the valve device 901 into the support 902.

As shown in FIGS. 9A and 9C, the pressure balancing assembly also has a support 902 which is similar to the support 102 in FIG. 3A. The support 902 has a ledge portion 941 which is similar to the ledge portion 341 of the support 102. The differences between the support 902 and the support 102 are described in the below. Unlike the support 102, a snap-fit portion 990 of the support 902 extends from the ledge portion 941 toward the central axis of the valve body 911 to have a substantially annular shape. A distal end of the snap-fit portion 990 forms a protrusion 975 which can engage with the connecting portions 930. The protrusion 975 continuously extends in the circumferential direction. For the ease of illustration, dotted lines are used in FIG. 9C to show the ledge portion 941, the snap-fit portion 990 and the protrusion 975. The snap-fit portion 990 is provided with through holes 956 extending in an axial direction of the valve body 911 and running through the snap-fit portion 990. The through holes 956 form fluid passages 988.

When the valve device 901 is mounted in the support 902, the protrusion 975 of the snap-fit portion 990 engages the step surfaces 957 of the connecting portions 930 above the step surfaces 957. When the internal pressure of the mounting part is too large, fluid flows through the fluid passages 988 to the flange 913, such that the flange 913 is deformed to disengage from the ledge portion 941.

In this embodiment, the connecting portions 930 are also made of the second material having a certain hardness, which also makes it possible that the valve device 901 is unlikely to be disengaged from the support 902.

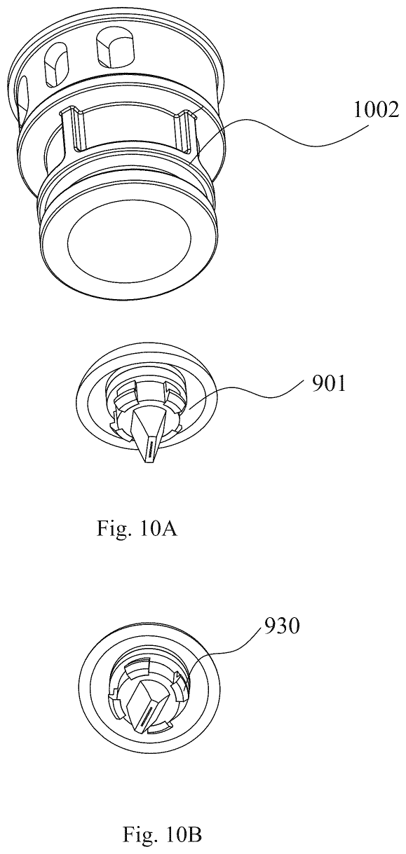

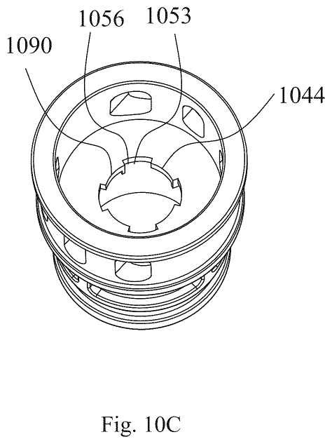

FIG. 10A is an exploded perspective view of a valve device and a support of a pressure balancing assembly according to a fourth embodiment of the present disclosure, FIG. 10B is a perspective view of the valve device in FIG. 10A, and FIG. 10C is a perspective view of the support in FIG. 9A.

As shown in FIGS. 10A and 10B, the valve device 901 in FIG. 9B is used in this fourth embodiment. The support 1002 in FIGS. 10A and 10C is similar to the support 102 in FIG. 9A, but has different configuration of the snap-fit portion from the support 102.

As shown in FIG. 10C, the support 1002 has a snap-fit portion 1090. The snap-fit portion 1090 includes a plurality of grippers 1044. The plurality of grippers 1044 extend in a radial direction toward a central axis of the support 1002. A recess portion 1053 is formed between adjacent grippers of the plurality of grippers 1044. The recess portions 1053 are sized to allow the connecting portions 930 of the valve device 901 to enter thereinto. When the valve device 901 is mounted into the support 1002, the connecting portions 930 are first aligned with the recess portions 1053, the valve device 901 is then inserted into the mounting cavity until the second segments 973 of the connecting portions 930 pass over a distal end of the snap-fit portion 1090 in the axial direction of the support 102. Next, the valve device 901 is rotated such that the connecting portions 930 are aligned with the grippers 1044. At this moment, the spacing portions 940 and the recess portions 1053 are aligned with each other and thus form fluid passages 1056, and the snap-fit portion 1090 engages the step surfaces 957 above the step surfaces 957.

The valve device of the pressure balancing assembly in the present disclosure is made of two materials. The flange and the closure mouth of the valve passage on/off portion made of a first material having a certain elasticity allow fluid from the outside enters into the interior of the mounting part or allows the fluid within the interior of the mounting part to flow to the outside, so as to regulate the internal pressure of the mounting part. The connecting portion of the valve device which is made of the second material having a certain hardness protects the valve device from deforming to disengage from the support due to the pressure. In some embodiments of the present disclosure, the support having grippers can facilitate connection of the support to the valve device.

Although the present disclosure is described with reference to the examples of the embodiments outlined above, various alternatives, modifications, variations, improvements and/or substantial equivalents, which are known or can be anticipated at present or to be anticipated before long, may be obvious to those of at least ordinary skill in the art. In addition, the technical effects and/or technical problems described in this specification are exemplary rather than limiting; Therefore, the disclosure in this specification may be used to solve other technical problems and may have other technical effects. Accordingly, the examples of the embodiments of the present disclosure as set forth above are intended to be illustrative rather than limiting. Various changes may be made without departing from the spirit or scope of the present disclosure. Therefore, the present disclosure is intended to encompass all known or earlier disclosed alternatives, modifications, variations, improvements, and/or substantial equivalents.

What is claimed is:

1. A valve device comprising:
a valve body, the valve body having a first axial end, a second axial end, and a valve passage running through the valve body from the first axial end to the second axial end, the first axial end and the second axial end being disposed opposite to each other, and an outer side portion in a circumferential direction of the valve body comprising a connecting portion configured to connect the valve device to a part to be connected;
a valve passage on/off portion connected to the first axial end of the valve body and made of a first material having elasticity, the valve passage on/off portion being deformable to open or close the valve passage; and
a flange connected to the second axial end of the valve body and obliquely extending outwardly in a direction toward the first axial end such that a distal end of the flange is located outside the valve body in a radial direction of the valve device, wherein the distal end of the flange has a contact portion;
wherein the connecting portion is made of a second material, and the elasticity of the second material is less than that of the first material.

2. The valve device of claim 1, wherein the flange is made of the first material, or an elastic material apart from the first material.

3. The valve device of claim 1, wherein the connecting portion and valve passage on/off portion are formed into an integral unit by means of a secondary injection molding process.

4. The valve device of claim 1, wherein the connecting portion is configured to be in connection with the part to be connected by means of a snap-fit structure.

5. The valve device of claim 4, wherein, in an axial direction of the valve body, the valve body comprises a front valve body segment, and the connecting portion comprises a first connecting portion segment and a second connecting portion segment, wherein the first connecting portion segment is connected to the front valve body segment, the second connecting portion segment is closer to the valve passage on/off portion than the first connecting portion segment, and the size of an outer periphery of the first connecting portion segment is less than the sizes of the front valve body segment and the second connecting portion segment, such that a groove is formed between the second connecting portion segment, the first connecting portion segment and the front valve body segment, and the connecting portion continuously extends or is intermittently arranged in the circumferential direction.

6. The valve device of claim 5, wherein the valve body comprises a plurality of the grooves, which are arranged along the axial direction of the valve body, with a space between adjacent grooves of the plurality of the grooves.

7. The valve device of claim 1, wherein the valve passage on/off portion comprises a closure mouth having a slit at the distal end, the closure mouth comprises a pair of lips, each of the pair of lips having an inner side portion and an outer side portion, and the pair of lips being configured to be deformable, such that the slit is opened when the pair of lips is subjected to an outward pressure applied to the inner side portions, and the slit is closed when the pair of lips is subjected to an inward pressure applied to the outer side portions.

8. A pressure balancing assembly comprising:
a support, the support comprising a side wall and a mounting cavity, the side wall enclosing the mounting cavity, and a ledge portion being provided on an inner side of the side wall and continuously extending in a circumferential direction; and
the valve device of claim 1, the valve device being mounted in the mounting cavity and connected to the support via the connecting portion, wherein the pressure balancing assembly has fluid passages, the flange being configured to abut against or disengage from the ledge portion to close or open the fluid passages.

9. The pressure balancing assembly of claim 8, wherein the mounting cavity has a first cavity end and a second cavity end in the axial direction of the valve body, and when the pressure balancing assembly is configured such that when a pressure at the first cavity end is greater than a pressure at the second cavity end, fluid can flow from the valve passage and the valve passage on/off portion to the second cavity end; and when the pressure at the first cavity end is less than the pressure at the second cavity end, the fluid can flow from the fluid passages to the first cavity end.

10. The pressure balancing assembly of claim 8, wherein one of the support and the valve body comprises a protrusion, and the other comprises a groove; and in the axial direction of the valve body, the height of the groove is greater than the height of the protrusion, and the protrusion is movable in the groove in the axial direction of the valve body, such that the valve device can move in the mounting cavity in the axial direction of the valve body.

11. The pressure balancing assembly of claim 10, wherein the support comprises a snap-fit portion extending from the inner side of the side wall toward a center line of the support, a distal end of the snap-fit portion forming the protrusion, and at least a portion of the fluid passages being located between the protrusion and the ledge portion and extending in an axial direction of the support to run through the snap-fit portion; and, in the axial direction of the valve body, the valve body comprises a front valve body segment, and the connecting portion comprises a first connecting portion segment and a second connecting portion segment, wherein the first connecting portion segment is connected to the front valve body segment, the second connecting portion segment is closer to the valve passage on/off portion than the first connecting portion segment, and the size of an outer periphery of the first connecting portion segment is less than the sizes of the front valve body segment and the second connecting portion segment, such that a groove is formed between the second connecting portion segment, the first connecting portion segment and the front valve body segment and is capable of accommodating a plurality of the protrusions.

12. The pressure balancing assembly of claim 11, wherein the snap-fit portion comprises a plurality of grippers, which respectively extending from the inner side of the side wall toward the center line of the support, distal ends of the plurality of grippers forming the plurality of protrusions, adjacent grippers of the plurality of grippers having a space therebetween to form recess portions which form at least a portion of the fluid passages.

13. The pressure balancing assembly of claim 12, wherein the plurality of grippers extend from an inner side of the ledge portion, angled away from the flange.

14. The pressure balancing assembly of claim 13, wherein the groove continuously extends in a circumferential direction.

15. The pressure balancing assembly of claim 12, wherein a plurality of the connecting portions are arranged in a spaced manner in the circumferential direction, spacing portions are disposed between adjacent connecting portions, and the size of an outer periphery of the spacing portion is less than the size of the outer periphery of the first connecting portion segment; and the valve device is configured to enable the plurality of the connecting portions to be inserted into the recess portions in the axial direction of the valve body and be rotated by an angle after being inserted in place, such that the spacing portions and the recess portions are aligned and together form the fluid passages.

16. The pressure balancing assembly of claim 11,
Wherein the distal end of the snap-fit portion continuously extends in the circumferential direction, the snap-fit portion has through holes extending in the axial direction of the valve body and running through the snap-fit portion, and the through holes form the fluid passages; and
wherein the connecting portions are arranged in a spaced manner in the circumferential direction.

17. The pressure balancing assembly of claim 8, wherein
the pressure balancing assembly further comprises a cover, the cover comprising a cover body portion connected to one end of the support; and the side wall further comprises flow ports, the flange and the flow ports being located between the cover body portion and the ledge portion in the axial direction of the valve body.

18. The pressure balancing assembly of claim 17, wherein
the cover further comprises a cover extension portion, the cover extension portion extending from an edge of the cover body portion in the axial direction of the valve body, having a space with the side wall, and being provided with a thread capable of being connected to the connected part.
